(19) United States
(12) Patent Application Publication
(10) Pub. No.: US 2006/0016192 A1
(43) Pub. Date: Jan. 26, 2006

(54) Turbojet with protection means for a fuel injection device, an injection device and a protective plate for the turbojet

(75) Inventors: Jacques Marcel Arthur Bunel, Fresnes (FR); Jacques Andre Michel Roche, Lisses (FR); Alain Pierre Page, Montgeron (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SNECMA, Paris (FR)

(21) Appl. No.: 11/175,191

(22) Filed: Jul. 7, 2005

(30) Foreign Application Priority Data
Jul. 21, 2004 (FR) 04 08059

(51) Int. Cl. F02K 3/10

(52) U.S. Cl. 60/761

(57) ABSTRACT

The turbojet of the invention includes a combustion chamber, a channel for heating the gas stream, where the heating channel includes at least one device for injection of fuel into the gas stream, which includes an open chamber, with a U-shaped section, having at least one wall within which extend fuel-injection means, which inject the fuel in at least one direction. It is characterised by the fact that a cooling jacket is provided in the chamber, alongside the wall forming the base of its U-section, and the fuel injection device includes protection means interposed between the fuel-injection means and the wall, in a fuel-injection direction. Thus, as a result of the invention, the fuel injection device, which is bathed in a very hot environment, is protected against thermal shocks due to the projection of colder fuel onto its walls, and its life expectancy is therefore increased.

The invention concerns a turbojet which has a channel for heating of the primary gas flow, with a fuel injection device and protection means for the fuel injection device. The invention also concerns a fuel injection device and a protective plate for the said turbojet.

Turbojets which are described as “post combustion” generally include, from upstream to downstream in the direction of flow of the gases, one or more compressor stages, a combustion chamber, one or more turbine stages, a heating or post combustion channel, and an exhaust nozzle. The primary gas flow, downstream of the turbine stages, allows a fresh combustion, as a result of the oxygen still present within it, in the heating channel before expanding in the exhaust nozzle.

At the entrance of the heating channel, flame holder arms extend radially into the gas stream. They are of U-shaped section, the branches of the U being orientated in the downstream direction, and have within them a fuel injector projecting the latter into the stream of gas in the downstream direction. The fuel is ignited and the flames are attached to the walls of the arms because the shape of the arm section creates a zone with a lower pressure. A flame holder ring, concentric with the housing of the heating channel, can also be provided in the gas jet of the primary stream. This functions on the same principle.

The primary stream is at a temperature of about 950° C. The walls of the flame holder arms, although cooled by a jacket fed with air from the secondary air stream at 200 or 250° C., are at a temperature of around 800 to 850° C., in particular at their trailing edge, while the flames attached to the arms are at a temperature of 1700° C. The fuel is projected at a temperature of about 100° C., or more precisely between 50 and 150° C., against the walls of the arm at 850° C.

The thermal gradients resulting from this impact are very large, and lead to deformation of the arms, in particular at their trailing edge. Because of this, their life expectancy is reduced, this being all the more serious since the arms are generally made from castings in Colbalt-based alloys, and are difficult to replace. The maintenance costs are therefore very high.

In the case of an annular injection device with two walls forming a chamber that is open upstream and downstream, document U.S. Pat. No. 5,179,832 proposes, a protective plate adjacent to the external wall, against which the fuel is projected. The fuel is projected by a fuel injector tube standing away from the inner end of the upstream jet of the chamber. Such protection is not satisfactory however, in the case of a chamber that is closed on the upstream side.

This present invention aims to overcome these drawbacks.

To this end, the invention concerns a turbojet that includes a channel for heating of the gas stream, where the heating channel includes at least one device for the injection of fuel into the gas stream, which includes an open chamber with a U-shaped section and with at least one wall, and within which extend of fuel-injection means which inject the fuel in at least one direction, characterised by the fact that a cooling jacket is provided in the chamber, alongside the wall forming the base of its U-section, and the fuel injection device includes protection means interposed between the fuel-injection means and the wall, in a fuel-injection direction.

Preferably, the protection means include at least one plate.

Again preferably, the injection device comes in the form of a radial arm.

Advantageously in this case, the protection means extend along the full radial height of the arm.

Preferably again, the fuel-injection means include at least one tube, supplied with fuel and including fuel-injection orifices.

Advantageously, the fuel injection device also includes a protective screen, placed in the opening of the chamber, the protection means being positioned between a wall of the chamber and the protective screen.

Depending on the form of implementation, the fuel-injection means are placed between the walls forming the branches of the U-section of the chamber.

Preferably in this case, a plate is placed more or less parallel to each of the walls of the chamber forming the branches of its U-section.

Depending on the form of implementation, each plate is attached to the wall to which it is more or less parallel.

According to another form of implementation, each plate is attached to the cooling jacket.

According to yet another form of implementation, the plate includes a U-section, and a radial recess in the central part of the wall forming the base of its U-section, which is slid onto a part forming a slide, attached to the cooling jacket.

The invention also concerns a fuel injection device for the above turbojet.

The invention again concerns a protective plate for a fuel injection device for the above turbojet.

The invention will be better understood with the aid of the following description of the preferred form of implementation of the turbojet of the invention, with reference to the appended drawings, in which:

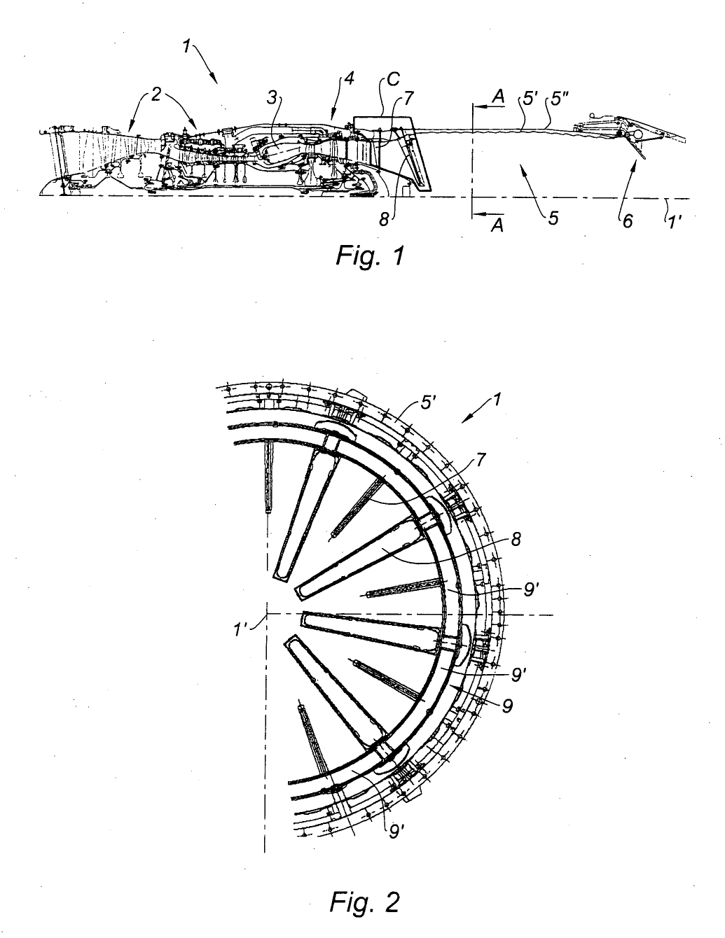

FIG. 1 represents a partial view in axial section of the preferred form of implementation of the turbojet of the invention;

FIG. 2 represents a view in transverse section of the turbojet of FIG. 1, in direction A-A;

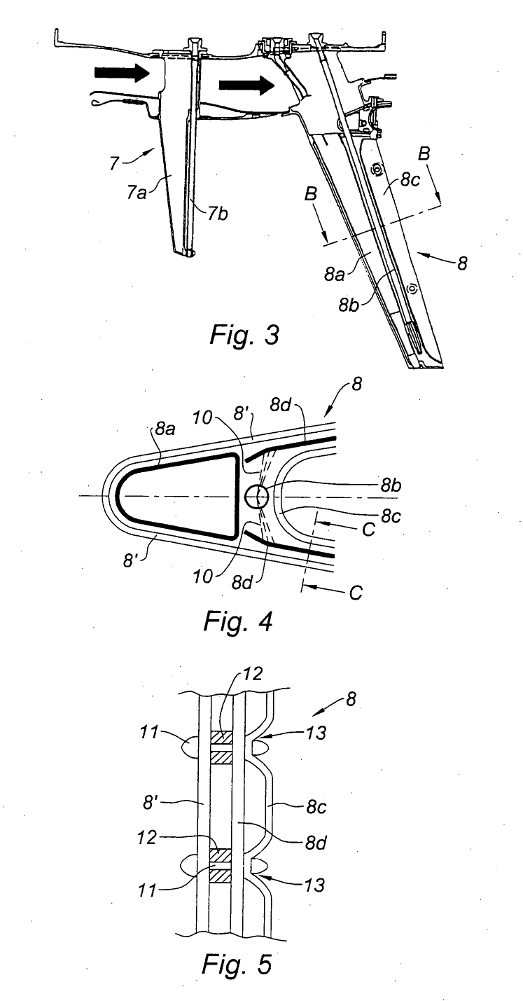

FIG. 3 represents an enlarged view of the area of FIG. 1 contained in frame C;

FIG. 4 represents a view in section of the flame holder arm of FIG. 3, in direction B-B;

FIG. 5 represents a view in section of the flame holder arm of FIG. 4, in direction C-C;

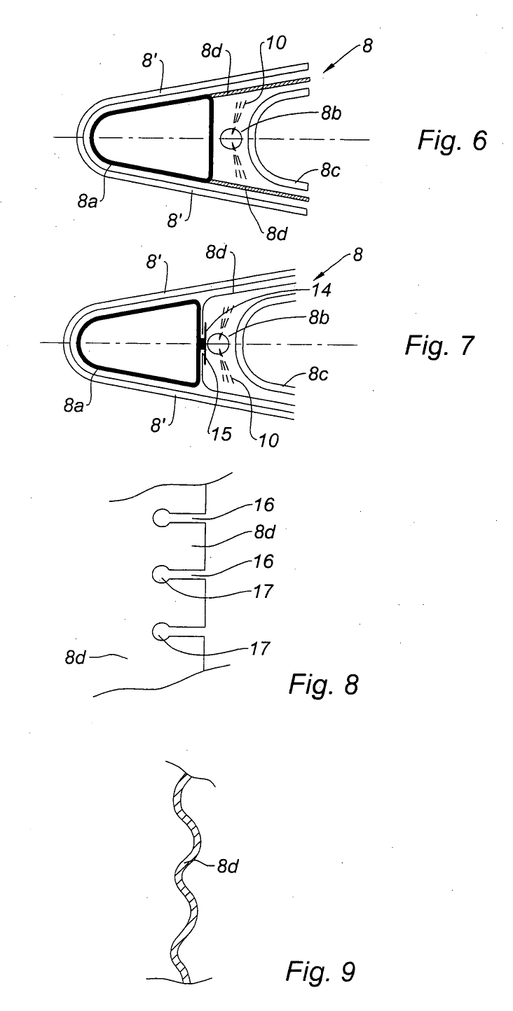

FIG. 6 represents a view in section of a second form of implementation of the flame holder arm of the turbojet of the invention;

FIG. 7 represents a view in section of a third form of implementation of the flame holder arm of the turbojet of the invention;

FIG. 8 represents a schematic outline view of a particular form of implementation of the protective plate of the flame holder arm of the turbojet of the invention and

FIG. 9 represents a view in schematic section of another particular form of implementation of the protective plate of the flame holder arm of the turbojet of the invention.

With reference to FIG. 1, the turbojet 1 of the invention, which extends along an axis 1′, includes several compressor stages 2, a combustion chamber 3, several turbine stages 4, a channel for heating of the primary stream 5 and an exhaust nozzle 6. The heating channel 5 is delimited by an internal jacket 5′ surrounded by a external housing 5″. These two elements 5′, 5″ delimit between them a passage for cooling air.

At the entrance of the heating channel 5, fuel-injector arms 7, attached to the external housing 5″ and to the internal jacket 5′ of the heating channel 5, extend radially. The function of the injectors is to vaporise fuel in the direction of flame holder arms 8, located downstream in the heating channel 5.

With reference to FIG. 2, the flame holder arms 8 are the same in number, here nine, as the fuel-injector arms 7 and are angularly offset in relation to the latter, so that when viewed face on, each fuel injector arm 7 is located between two adjacent flame holder arms 8, and equidistant from each. The fuel-injector arms 7 are radially smaller than the flame holder arms 8.

Close to the internal jacket 5′ of the heating channel 5, in the heating channel of the primary stream 5, the flame holder arms 8 support a flame holder ring 9. This ring 9 is composed of a multiplicity of portions of ring 9′, nine in number, which extend, concentrically to the housings 5′, 5″ of the heating channel 5, between two successive flame holder arms 8.

With reference to FIG. 3, a fuel injector arm 7 includes a radial cooling jacket 7a, extending over all of the radial height of the arm 7, parallel to which extends, downstream, a fuel injector tube 7b, supplied with fuel from the exterior of the external housing 5″ of the heating channel 5 and including fuel vaporisation jets. The cooling jacket 7a is fed with cooling air, taken from the secondary air stream. It includes jets which are used to cool the arm 7 by air impact. The fuel-injector arms 7 extend radially at right angles to the axis 1′ of the turbojet 1.

The flame holder arms 8 extend radially, inclined in the downstream direction, from their base attached to the external housing 5″ of the heating channel 5, in relation to the perpendicular to the axis 1′ of the turbojet 1 contained in the axial plane of the arm 8. A flame holder arm 8 includes an open chamber, delimited by walls 8′—which can be replaced in a similar manner by a continuous wall 8′—in which its various elements are contained. The flame holder arm includes a radial cooling jacket 8a, extending over all of the radial height of the arm 8, parallel to which extends, downstream, a fuel injector tube 8b, supplied with fuel from the exterior of the external housing 5″ and including jets for projection of the fuel.

The simplified operation of the turbojet is as follows. Fuel is vaporised by the fuel injector tubes 7b of the fuel-injector arms 7 and by the fuel injector tubes 8b of the flame holder arms 8. As a result of the residual oxygen in the primary gas flow, and also due to a contribution of air from the secondary stream, this fuel undergoes combustion. This combustion occurs at the flame holder arms 8, the shape of which causes the attraction of the flames by the said arms 8. This combustion, known as post combustion or re-heating, provides additional impulsion to the turbojet. This process of post combustion is well known to the professional engineer and will therefore not be treated in greater detail here. The gas then expands in the heating channel 5 and in the exhaust nozzle 6 before of being ejected out of the turbojet 1.

With reference to FIG. 4, the external walls 8′ of a flame holder arm 8, delimiting its open chamber, present a U-section, the branches of which are turned in the downstream direction. More precisely, the branches of the U are not parallel; they are more like a V with a rounded base; in the remainder of the document however, we will speak of a U-section. The cooling jacket 8a occupies the upstream portion of this U-section, that is its closed portion. This jacket 8a includes a multiplicity of jets, typically nine hundred in number, by which the air of the secondary stream with which it is fed is projected, in order to cool the walls 8′ of the arm 8. Just downstream, centred in relation to the walls 8′, extends the fuel injector tube 8b. Downstream of this tube 8b extends a protective screen 8c, also of U-section, the function of which is to protect the fuel injector tube 8b and the cooling jacket 8a of the flame attracted to the trailing edges of the walls 8′ of the arm 8. This screen 8c occupies virtually all the space left between the extremity of the walls 8′ of the arm 8 forming the branches of its U-section.

A protective plate 8d extends between the walls of the protective screen 8c and the walls 8′ of the arm 8. Its function is to prevent a direct impact of the fuel onto the walls 8′ of the arm 8, the drawbacks of which have been presented above. In the form of implementation of FIG. 4, the flame holder arm 8 includes two protective plates 8d, extending more or less parallel to the two walls 8′ forming the branches of the U-section of the arm 8, from the cooling jacket 8a, though not in contact with it and forming, in its proximity, a slight elbow inside the arm, up to the trailing edges of the arm 8. The plates 8d extend over all of the radial height of the arm 8.

Thus the fuel, indicated by dashed lines 10, is sprayed from the fuel injector tube 8d onto the protective plates 8d, before being ejected, between the said plates 8d and the protective screen 8c, beyond the arm 8, where it is ignited.

In FIG. 5 we see the method for attaching a protective plate 8d within an arm 8. The protective plate 8d is attached to the wall 8′ of the arm 8, to which it is more or less parallel, by securing pins 11 passing through holes that have been provided for this purpose in the plate 8d and the wall 8′. In order to keep an adequate distance between the wall 8′ of the arm 8 and the protective plate 8d, this distance being necessary for a certain thermal independence between these two elements and therefore for acceptable protection of the wall 8′ of the arm 8, spacers 12 are positioned between their facing surfaces, around the securing pins 11.

The protective screen 8c is fixed to the protective plate 8d at the portions of its walls that correspond to the branches of its U-section, by the same securing pins 11. Such a portion of wall generally takes the form of a plate, including indentations 13 in which holes are drilled for passage of the securing pins 12. Thus, the screen 8c is pinned onto the plate 8d at the location of the indentations 13, while the major part of its surface is held away from the plate 8d, so as to leave a space for passage of the fuel 10.

The securing pins 11 are not specified, and will be chosen by the engineer concerned.

As a result of the protective plates 8d, the fuel 10 projected by the tube 8b does not make contact with the walls 8′ of the arm 8, the temperature of which is very high, and so prevents them from being subjected to excessive temperature gradients. It is projected onto the protective plates 8d, which are located inside the space defined by the walls 8′ of the arm 8, and are at a lower temperature, due in particular to the cooling provided by the jacket 8a. Their temperature is typically 600 to 650° C., instead of 850° C. for the walls 8′ of the arm 8. The thermal gradient to which they are subjected is therefore less severe. The plates 8d can be composed of any ad-hoc material, such as metal, ceramics or ceramic matrix components (CMC).

The plates 8d thus protect the walls 8′ of the arm 8, since they are placed between the tube 8b and the walls 8′ of the arm, in the fuel-injection direction. They undergo deformations, but once deformed, they are easily to replace, or at least easier than the walls 8′ of the arm 8, resulting in lower maintenance costs than for structures of earlier design.

Other methods of attachment and other shapes of the protective plates 8d can also be envisaged.

With reference to FIG. 6, a plate 8d can be attached directly to the cooling jacket 8a. In this case, the arm 8 includes two protective plates 8d, extending more or less parallel to the two walls forming the branches of the U-section of the arm 8, these two plates 8d being fixed to the cooling jacket 8a of the arm 8, in its downstream portion. Attachment can be by any means of attachment. The plates 8d preferably extend up to the trailing edges of the arm 8, over all of its radial height. The plates 8d can either be attached to the cooling jacket 8a or fixed to the walls 8′ of the arm 8, in the same way as before, for example. Operation of the arm 8 and protection of the walls 8′ by the protective plates 8d are similar to those described previously. The advantage of this solution is the continuity between the protective plates 8d and the cooling jacket 8a, excluding all possible contact between the fuel and the walls 8′ of the arm 8.

With reference to FIG. 7, it is possible to provide a U-section plate 8d, that includes a radial recess 15 in the central part of the wall forming the base of its U-section, extending from a radial extremity of the plate 8d virtually up to its other radial extremity. The plate 8d is slid into a T-section part 14 attached to the cooling jacket 8a by the base of the T. This part 14 thus forms a slide for the protective plate 8d, at the level of its recess 15, which is slid onto it up to the point where its unrecessed radial extremity comes up against part 14. It can be locked to part 14. Thus, the protective plate 8d protects not only the walls 8′ of the arm 8 by means of the walls forming the branches of its U-section, extending up to the trailing edge of the arm 8, but also the cooling jacket 8a by means of the wall forming the base of its U-section, completed by the wall of the slide 14 forming the bar of its T-section. The operation of the arm 8 and its protection by the protective plate 8d are otherwise quite comparable to what we have seen previously. The advantage of this method of implementation of the protective plate 8d is its ease of replacement, by a simple sideways movement in the slide 14. In addition, the plate 8d takes the form of a single part, to protect all of the walls 8′ of the arm 8.

In order to increase its life expectancy, the protective plate 8d, in its downstream area close to the trailing edge of the arm 8, can be shaped otherwise than a simple plate, irrespective of its overall shape.

With reference to FIG. 8, the downstream end wall of the protective plate 8d can include slots 16, which are used to absorb the deformations to which the plate 8d is subjected. These slots 16 can be completed, where appropriate, by circular recesses 17 at their upstream ends, which then allows even greater deformations of the portions of plate 8d located between two slots 16.

According to another form of implementation, the walls of the plate 8d can present, in their downstream end portion, or even over all of their wall that is more or less parallel to a wall 8′ of the arm 8, a section, seen in transverse section in relation to the general plane of the wall, of corrugated shape, which allows the deformations associated with the thermal gradients to be absorbed. In fact, this type of corrugation is generally the result of the deformations, and being able to do it in advance allows one to pre-stress the plate 8d to some degree.

The invention has been presented in relation to a fuel injection device in the primary gas flow which is a radial arm, but it goes without saying that the invention applies to all types of fuel injection device in the primary gas flow, and a ring in particular.

1- A turbojet, including a channel for heating of the gas stream, the heating channel including at least one device for the injection of fuel into the gas stream, which includes an open chamber, with a U-shaped section, having at least one wall and within which extend fuel-injection means, which inject the fuel in at least one direction, characterised by the fact that a cooling jacket is provided in the chamber, alongside the wall forming the base of its U-section, and the fuel injection device includes protection means interposed between the fuel-injection means and the wall, in a fuel-injection direction.

2- A turbojet in accordance with claim 1, in which the protection means include at least one plate.

3- A turbojet in accordance with claim 1, in which the injection device takes the form of a radial arm.

4- A turbojet in accordance with claim 3, in which the protection means extend over all of the radial height of the arm.

5- A turbojet in accordance with claim 1, in which the fuel-injection means include at least one tube, supplied with fuel and including fuel-injection jets.

6- A turbojet in accordance with claim 1 in which, the fuel injection device also includes a protective screen, placed in the opening of the chamber, the protection means being positioned between a wall of the chamber and the protective screen.

7- A turbojet in accordance with claim 1, in which the fuel-injection means are placed between the walls forming the branches of the U-section of the chamber.

8- A turbojet in accordance with claims 2 and 7 together, in which a plate is placed more or less parallel to each of the walls of the chamber forming the branches of its U-section.

9- A turbojet in accordance with claim 8, in which each plate is attached to the wall to which it is more or less parallel.

10- A turbojet in accordance with either of claims 8 or 9 in which each plate is attached to the cooling jacket.

11- A turbojet in accordance with claims 2 and 7 together in which the plate includes a U-section and a radial recess in the central part of the wall forming the base of its U-section, which is slid onto a part forming a slide, attached to the cooling jacket.

12- A turbojet in accordance with claim 2, in which the plate includes slots.

13- A turbojet in accordance with claim 2, in which the plate includes a portion of corrugated wall.

14- A turbojet in accordance with claim 1, in which the injection device comes in the form of a ring.

15- A fuel injection device for a turbojet in accordance with claim 1.

16- A protective plate for a fuel injection device for a turbojet in accordance with claim 2.
